(19) United States
(12) Patent Application Publication
(10) Pub. No.: US 2008/0048161 A1
(43) Pub. Date: Feb. 28, 2008

(54) Trailer hitch installation support

(76) Inventor: Randall J. Meyer, Mesa, AZ (US)

Correspondence Address: LITMAN LAW OFFICES, LTD., P.O. BOX 15035, CRYSTAL CITY STATION, ARLINGTON, VA, 22215, US

(21) Appl. No.: 11/822,736

(22) Filed: Jul. 9, 2007

Related U.S. Application Data
(60) Provisional application No. 60/840,052, filed on Aug. 25, 2006.

(51) Int. Cl. B66F 5/04; B66F 5/02

(52) U.S. Cl. 254/2 R; 254/93 R

(57) ABSTRACT

The trailer hitch installation support temporarily supports a receiver hitch or the like beneath a vehicle during the installation process, thereby precluding need for the installer to support the hitch while simultaneously performing the tasks associated with hitch installation. The hitch installation support includes a lifting and support mechanism (scissor or bottle jack, etc.) mounted upon a low, wheeled platform. The mechanism includes a receiver hitch fitting thereatop. The jack may be manually actuated, but jack actuation may be powered by a separate power tool or integral drive motor, in at least some embodiments. The receiver hitch is temporarily attached to the hitch fitting of the device, or to an adapter extending from the fitting, and the support and hitch are positioned beneath the vehicle. The hitch is then raised to its installed position beneath the vehicle, with the support holding the hitch in place during the installation process.

### CROSS-REFERENCE TO RELATED APPLICATION

This application claims the benefit of U.S. Provisional Patent Application Ser. No. 60/840,052, filed Aug. 25, 2006.

### BACKGROUND OF THE INVENTION

1. Field of the Invention

The present invention relates generally to adjustable brackets and supports for temporarily holding various objects. More specifically, the present invention is a trailer hitch installation support that provides a vertically adjustable device, e.g., a scissor jack, bottle jack, or the like, having a fitting attached thereto for removably holding the receiver end of a receiver hitch.

2. Description of the Related Art

Light trucks, such as pickup trucks, sport utility vehicles, and vans, have become increasingly popular due to their versatility and load carrying capacity. Most such vehicles have the capability of towing a trailer if properly equipped, thus further increasing their versatility and capacity. In the past, it was common to install a simple ball type hitch directly to the rear bumper of a vehicle in order to enable the vehicle to tow a trailer. However, as the structure of bumpers on automobiles and many other vehicles has changed due to crash protection requirements, and as trailer weights have increased, the standard hitch is now the receiver hitch, which is bolted to the frame or other structure of the towing vehicle.

Receiver hitches are considerably more durable than a simple ball hitch attached to the bumper of the towing vehicle, as the receiver hitch is attached (by bolts, etc.) directly to the structure of the vehicle, rather than to the bumper, which is generally attached to the body of the vehicle. However, the increased strength and durability provided by such an installation requires that the hitch be supported beneath the vehicle during the installation process. Even the lightest receiver hitch weighs on the order of twenty pounds or so, with hitches for higher classifications weighing even more. The temporary support of such a heavy hitch assembly during the installation process can be difficult.

A number of different lifting and supporting devices have been developed using the scissor jack principle. An example of such may be found in Japanese Patent Publication No. 52-009,260, published on Jan. 24, 1977. According to the drawings and English abstract, the device comprises a pair of parallel scissor jacks with a laterally translating element extending across the tops of the two jacks. No means is apparent for supporting a receiver hitch from the device, nor is any powered actuation apparent.

German Patent Publication No. 3,713,927, published on Nov. 10, 1988, describes (according to the drawings and English abstract) a “scissors-type platform” having a pantograph lifting leg assembly. The device is apparently actuated by a pair of hydraulic struts. A platform is provided at the top, but no means is provided for supporting a receiver hitch therefrom.

Thus, a trailer hitch installation support solving the aforementioned problems is desired.

### SUMMARY OF THE INVENTION

The trailer hitch installation support provides for the vertically adjustable support of a receiver hitch or the like, holding the hitch assembly in position beneath a vehicle during the installation process. The support enables the installer to work with both hands free and eliminates the need for the installer to support the heavy hitch assembly while simultaneously marking the locations for mounting holes, installing bolts, etc.

The hitch installation support is a low, wheeled platform with a lifting device, e.g., a scissor jack, hydraulic bottle jack, or the like, installed thereon. The jack includes an upper fitting providing for the temporary installation of a receiver hitch or the like thereto. Various adapters may be removably secured to the fitting to provide for the attachment of different sizes of hitches to the device. The lifting device may be manually actuated, but some form of power actuation (hand-actuated power tool, integral electric motor drive, etc.) is preferably used, at least in the scissor jack embodiments.

The device is used by fitting the appropriate adapter to the upper fitting, if needed, and temporarily installing the receiver hitch thereto using the conventional hitch attachment pin or other temporary fastener. The installation support with receiver hitch secured thereto is then positioned beneath the vehicle, and the receiver hitch is raised by means of the jack assembly to hold the hitch in position for installation. The installer is thus free to go about the various tasks involved in the actual installation of the hitch without concern for holding the hitch assembly in place during the installation process.

These and other features of the present invention will become readily apparent upon further review of the following specification and drawings.

### BRIEF DESCRIPTION OF THE DRAWINGS

FIG. 1 is an environmental, perspective view of a trailer hitch installation support according to the present invention, showing its use in the installation of a trailer hitch upon a vehicle.

FIG. 2 is a perspective view of the trailer hitch installation support according to the present invention, showing a series of supplemental fittings for use therewith and a power tool for use in actuating the support.

FIG. 3 is a perspective view of an alternative embodiment of a trailer hitch installation support according to the present invention having an actuating motor installed integrally therewith.

FIG. 4 is a perspective view of another alternative embodiment of a trailer hitch installation support according to the present invention using a hydraulic jack for actuation.

Similar reference characters denote corresponding features consistently throughout the attached drawings.

### DETAILED DESCRIPTION OF THE PREFERRED EMBODIMENTS

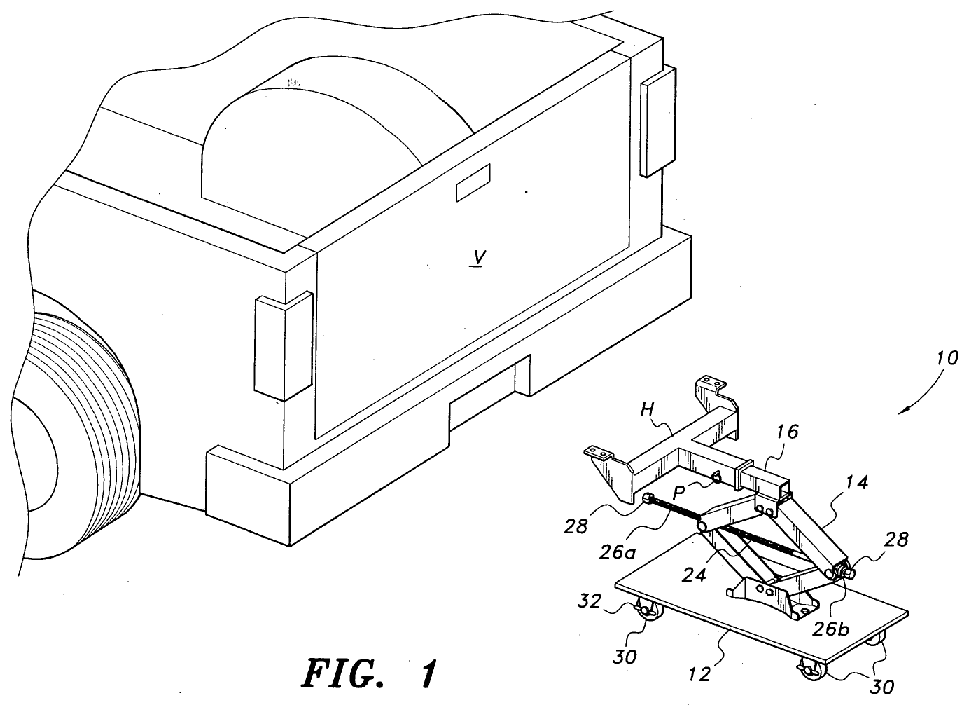

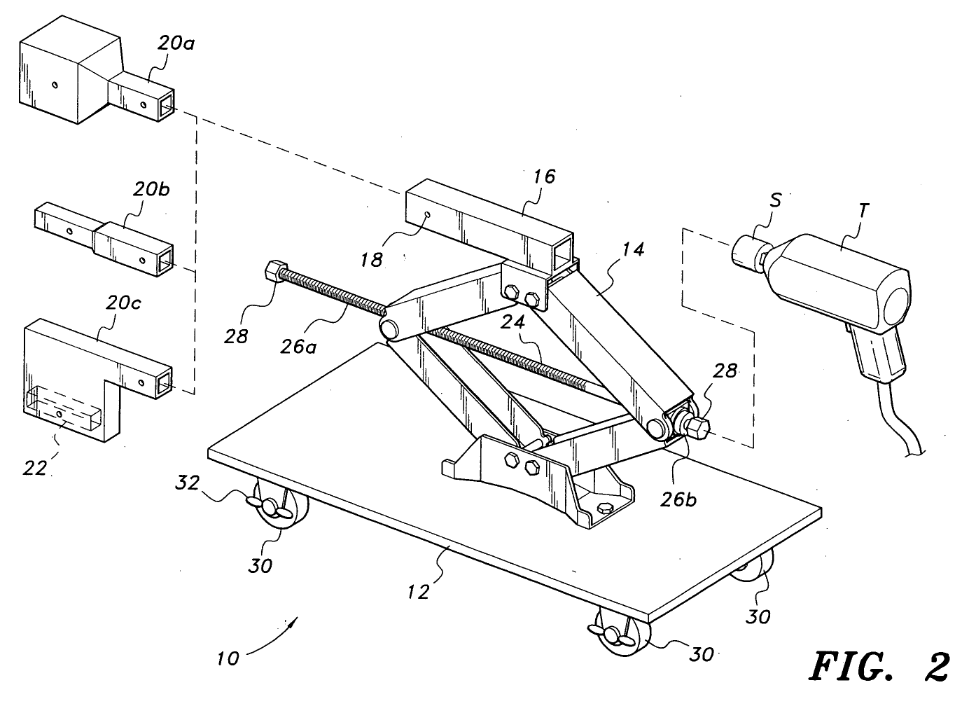

The present invention comprises various embodiments of a trailer hitch installation support for temporarily lifting and supporting a receiver hitch assembly or the like and holding the hitch assembly in position beneath a vehicle while the hitch assembly is installed. FIGS. 1 and 2 respectively provide environmental and detailed perspective views of the hitch installation support 10, with FIG. 2 also illustrating a series of accessories that may be provided with the device.

The hitch installation support 10 includes a low, flat platform 12, with a selectively adjustable lifting device permanently installed thereatop, e.g., bolted or welded in place, etc. The lifting device may comprise a scissor jack 14, as shown in FIGS. 1 and 2, or other type of manually actuated or power lifting device. The scissor jack 14 or other lifting device has a receiver hitch fitting 16 permanently installed (welded, bolted, etc.) thereatop. The receiver hitch fitting 16 may have a tubular square or rectangular section end configured for fitting closely within the conventional similarly shaped receptacle of a receiver hitch H, generally as shown in FIG. 1 of the drawings. A hitch pin passage 18 may be provided through the receiver hitch fitting 16, as shown in FIG. 2, providing for the removable installation of a hitch pin P therethrough (FIG. 1) to secure the receiver hitch H temporarily and removably to the device 10 during the hitch installation process.

Any of a series of adapters, e.g., adapters 20a through 20c of FIG. 2, may also be temporarily and removably secured to the hitch fitting 16 of the device by means of the hitch pin passage 18 and hitch pin P. The first adapter 20a has a larger hitch fitting to provide for the attachment of a larger or higher classification receiver hitch to the hitch installation support 10, if needed. The second adapter 20b has a smaller hitch fitting for the installation of smaller hitches, while the third adapter 20c includes a vertically offset receptacle 22 into which one of the other adapters 20a or 20b may be installed, to accommodate excessively high or low working heights during installation. It will be seen that the adapter 20c may be inverted from its orientation shown in FIG. 2, if necessary.

The scissor jack 14 includes a threaded jackscrew 24 extending therethrough, with the jackscrew having opposed ends 26a and 26b. A hexagonal or other configuration drive fitting 28 is affixed to one or both ends 26a, 26b of the jackscrew 24, and selectively mates with the correspondingly configured drive socket S of a power tool T, e.g., a conventional electric or pneumatic drill, pneumatic impact wrench, etc., as shown in FIG. 2 of the drawings. While the jackscrew 24 may be rotated manually to lift the top of the jack 14 and receiver hitch assembly H removably secured thereto, the use of a power tool T may accelerate and facilitate the operation.

The hitch installation support 10 includes a plurality of wheels 30 disposed beneath the platform 12 to facilitate placement of the support 10 beneath the vehicle V upon which the hitch H is being installed. The wheels 30 at one end of the platform 12 are preferably castered or pivotally mounted to facilitate maneuvering the device 10. At least one of the wheels 30 may include a selectively lockable brake, as indicated by the conventional brake lever 32 extending from one of the wheels 30 in FIGS. 1 through 4.

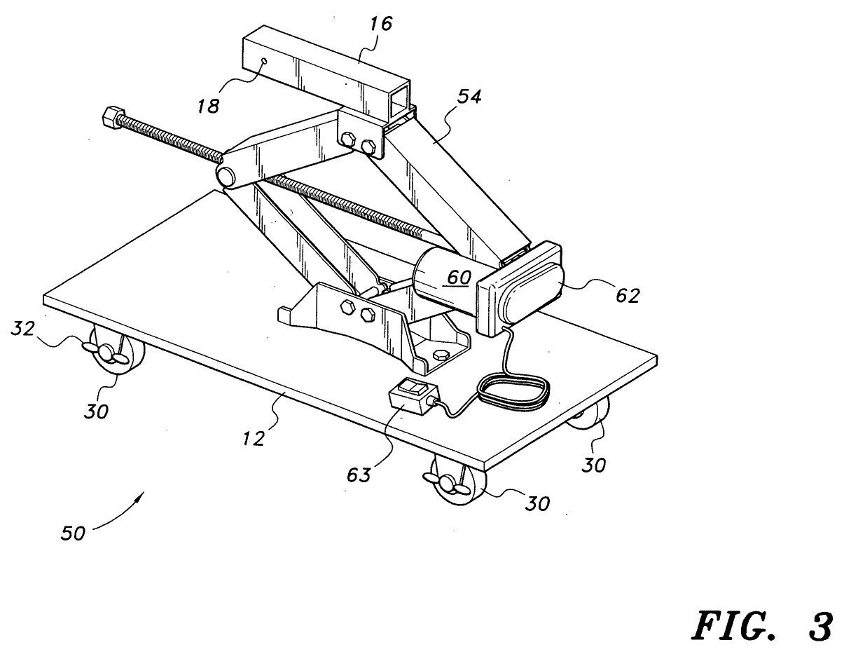

FIG. 3 illustrates an alternative embodiment of the trailer hitch installation support, designated as hitch support 50. The hitch support 50 includes a platform 12, which is supported by wheels 30, with at least one of the wheels 30 preferably including a brake mechanism 32, as in the case of the first embodiment 10 of FIGS. 1 and 2. A scissor jack apparatus 54 is permanently mounted atop the platform 12, with the jack 54 further including a receiver hitch fitting 16 permanently mounted thereon. However, the scissor jack 54 of the hitch support 50 of FIG. 3 differs from the scissor jack 14 of the embodiment of FIGS. 1 and 2 in that the scissor jack 54 is motorized.

An electric motor 60 is attached to the jack apparatus 54 as an integral component thereof, and mechanically communicates with the jackscrew 24 by means of a gearbox 62 or other suitable speed reduction and torque multiplication mechanism. The motor 60 may be controlled by a remote switch 63, and may receive power from a conventional electrical storage battery system or electrical power from the conventional electrical grid system. Alternatively, the motor 60 may comprise a pneumatically or hydraulically driven motor receiving power from a suitable source.

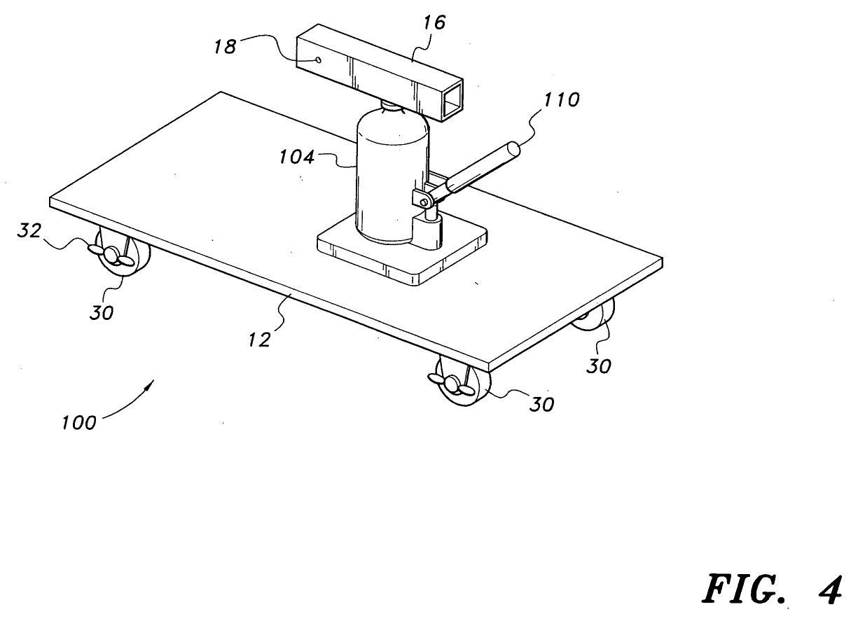

FIG. 4 of the drawings illustrates yet another embodiment of the trailer hitch installation support, designated as hitch support 100. The hitch support 100 has a similar configuration to the hitch supports 10 and 50 of FIGS. 1 through 3, i.e., a low, flat platform 12 supported by wheels 30 having at least one brake 32, with a jack or other lifting and supporting device permanently installed atop the platform 12. The jack has a receiver hitch fitting 16 permanently attached to the top or upper end thereof, as in the case of the embodiments of FIGS. 1 through 3.

However, the jack in the embodiment 100 of FIG. 4 differs from the other jacks, in that the jack comprises a relatively small, hydraulically actuated bottle jack 104. The bottle jack 104 is manually actuated by a lever handle 110, as in conventional bottle jacks. Alternatively, the jack 104 could be pneumatically actuated or hydraulically actuated from a remote pneumatic or hydraulic source of pressure.

The trailer hitch installation support in any of its various embodiments is used by initially lowering the jack apparatus to fit beneath the vehicle V to which the receiver hitch H is to be installed. Most such vehicles provide sufficient clearance therebeneath to allow the installer to roll beneath the vehicle V on a creeper or similar device; it is not necessary to use a lift to hoist the vehicle into the air. Accordingly, the hitch installation support provides sufficient vertical lift to position a hitch H secured thereto immediately adjacent the underside of the vehicle structure for mounting thereon.

The hitch installer then considers the class of hitch to be installed, and temporarily installs a suitable adapter, e.g., one of the adapters 20a through 20c illustrated in FIG. 2, on the hitch fitting 16 of the support if such an adapter is required. The hitch assembly H is then installed on the hitch adapter, or directly upon the hitch fitting 16, as appropriate. The hitch installation support is then rolled into position beneath the rear of the vehicle V, with the castering wheels facilitating maneuvering of the device as required.

At this point, the installer actuates the jack mechanism in accordance with the type of jack used with the device, e.g., applying a power hand tool T to one of the drive fittings 28 of the jackscrew 24 in the case of the device 10 of FIGS. 1 and 2. By providing a drive fitting 28 at both ends of the jackscrew, the installer may actuate the device from beneath the vehicle V, rather than being required to get out from under the vehicle to raise the hitch fitting 16 and temporarily attached hitch assembly H. The wheel brakes 32 are then set, once the hitch installation support is positioned as desired.

Once the hitch assembly H has been positioned as described above, the installer is free to mark the locations of bolt holes, etc. without need to support the hitch assembly H manually at the same time. The hitch support device with the hitch assembly H thereon may be easily moved to provide access to the vehicle structure for drilling holes, etc. Once the preparatory work has been completed, the hitch support device and hitch assembly H are moved back into position, holding the hitch assembly in position while the installer secures the hitch attachment bolts, etc. Once the hitch assembly H has been permanently secured in place beneath the vehicle, the installer need only remove the hitch pin P, release the wheel brake(s) 32, and back the hitch support device out from under the vehicle V, thereby withdrawing the receiver hitch fitting 16 (or adapter, if used) from the receiver hitch receptacle to complete the job.

In conclusion, the trailer hitch installation support, in its various embodiments, greatly facilitates the process of installing a relatively heavy and bulky receiver hitch assembly beneath a vehicle. The installer or mechanic is freed from the necessity of manually supporting the hitch assembly during the fitting and installation process, thereby greatly increasing the safety and efficiency of the operation. Accordingly, the device will be greatly appreciated by hitch installers, mechanics, and all others who may have occasion to install a receiver hitch or the like beneath a motor vehicle.

It is to be understood that the present invention is not limited to the embodiments described above, but encompasses any and all embodiments within the scope of the following claims.

I claim:

1. A trailer hitch installation support, comprising:
a low, flat platform;
a jack permanently installed upon the platform; and
a receiver hitch fitting permanently installed on the jack.

2. The trailer hitch installation support according to claim 1, wherein the jack is a scissor jack.

3. The trailer hitch installation support according to claim 2, further including a jack actuation motor disposed integrally with the scissor jack.

4. The trailer hitch installation support according to claim 2, further including:
a jackscrew disposed through the scissor jack, the jackscrew having mutually opposed first and second ends; and
a hexagonal drive fitting disposed upon at least one of the ends of the jackscrew.

5. The trailer hitch installation support according to claim 1, wherein the jack is a hydraulic bottle jack.

6. The trailer hitch installation support according to claim 1, further including a plurality of wheels disposed beneath the platform.

7. The trailer hitch installation support according to claim 6, further including a selectively actuated brake disposed upon at least one of the wheels.

8. The trailer hitch installation support according to claim 1, further including at least one receiver hitch adapter removably secured to the receiver hitch fitting of the jack.

9. A trailer hitch installation support, comprising:
a low, flat platform;
a scissor jack permanently installed upon the platform; and
a receiver hitch fitting permanently installed to the scissor jack.

10. The trailer hitch installation support according to claim 9, further including a jack actuation motor disposed integrally with the scissor jack.

11. The trailer hitch installation support according to claim 9, further including:
a jackscrew disposed through the scissor jack, the jackscrew having mutually opposed first and second ends; and
a hexagonal drive fitting disposed upon at least one of the ends of the jackscrew.

12. The trailer hitch installation support according to claim 9, further including a plurality of wheels disposed beneath the platform.

13. The trailer hitch installation support according to claim 12, further including a selectively actuated brake disposed upon at least one of the wheels.

14. The trailer hitch installation support according to claim 9, further including at least one receiver hitch adapter removably secured to the receiver hitch fitting of the jack.

15. A trailer hitch installation support, comprising:
a low, flat platform;
a hydraulic bottle jack permanently installed upon the platform; and
a receiver hitch fitting permanently installed to the bottle jack.

16. The trailer hitch installation support according to claim 15, further including a plurality of wheels disposed beneath the platform.

17. The trailer hitch installation support according to claim 16, further including a selectively actuated brake disposed upon at least one of the wheels.

18. The trailer hitch installation support according to claim 15, further including at least one receiver hitch adapter removably secured to the receiver hitch fitting of the jack.
